(19) United States
(12) Patent Application Publication
(10) Pub. No.: US 2010/0101407 A1
(43) Pub. Date: Apr. 29, 2010

(54) HYBRID NUTATING PUMP WITH ANTI-ROTATION FEATURE

(76) Inventors: William Harry Lynn, Bella Vista, AR (US); Roy Rozek, Plymouth, WI (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/532,394

(22) PCT Filed: Mar. 21, 2008
(86) PCT No.: PCT/US08/57793

§ 371 Date: Sep. 21, 2009

Related U.S. Application Data
(60) Provisional application No. 60/896,194, filed on Mar. 21, 2007.

(51) Int. Cl. F04B 1/32; F01B 13/02; B23P 11/00; F04B 49/00

(52) U.S. Cl. 91/505; 417/218; 417/269; 29/428

(57) ABSTRACT

A nutating or wobble type pump has at least one flexible member connected to the pump's yoke and the pump's housing. The flexible member does not have any sliding joints therein. The member flexes in a manner that allows the yoke to tilt relative to the pump's axis while restraining the yoke from rotating.

### FIELD OF THE INVENTION

This invention relates to pump's, and in particular, to nutating pump's.

### BACKGROUND OF THE INVENTION

Nutating pump's having a nutating member with a circular rocking or wobble type of motion to reciprocate pistons so as to result in pumping action are known. U.S. Patent Publication US2007/0022872 discloses such a mechanism. The patent application discloses a pump 10 having a housing 12. See prior art FIG. 1. The pump has a pair of compression pistons 14 opposite from one another (only one shown), the other one would be 180° degrees apart from the one shown. The pump also has a pair of vacuum pistons 16 (only one shown), the other vacuum piston 16 being opposite from the one shown, 180° degree there from about the axis of drive shaft 18. Each piston 14, 16 has a head 14A or 16A and a rod 14B or 16B, respectively. The heads 14A and 16A reciprocate with a slight wobble motion in respective pump cylinders 20 and 22. The invention could also be applied to a pressure-only or a vacuum-only pump, and in that case it would be desirable to provide an odd number of pistons, e.g., three or five, to minimize gas pulsations.

A cross-type universal joint 56 has two of its opposed arms journalled to connector 58 and the other two of its opposed arms (which are at 90° to the first two opposed arms mentioned) journalled to wobble member 60. Wobble member 60 mounts the outer race of a bearing and is pressed onto an eccentric stub shaft 64. The center of the universal joint 56 is on the axis of shaft 18. When the shaft 18 is rotated, the universal joint 56 permits the eccentric 64 to impart a wobbling motion to the wobble member 60 such that the two compression pistons 14 (which are 180° relative to each other about the axis of shaft 18) are 180° out of phase with one another and the two vacuum pistons 16, which are at 90° to the compression pistons 14 about the axis of shaft 18 (and which are 180° relative to each other about the axis of shaft 18), are 180° out of phase with one another.

The wobble member 60 has arms 74 which extend from it to the four piston rods 14B and 16B. The arms 74 extend into the respective piston rods and at their ends have ball head 76. The piston rods 14B and 16B are hollow and contain within them each a fixed socket half 78 and a biased socket half 80. Each fixed socket half 78 of the compressor piston rods 14B is held at a constant spacing from the piston head 14A by a spacer tube 82 which is contained within the rod 14B and the fixed socket half 78 of the vacuum piston rod 16B is held at a fixed spacing from the vacuum piston head 16A by the rod 16B being crimped over at its end 84. Biased socket half 80 of each compression piston rod 14B is biased toward the ball head 76 and toward the piston head 14A by a spring 86 which is held in the rod 14B by the crimp end 84. The socket half 80 of the vacuum piston 16 is biased against the ball head 76 and away from the piston head 16A by a spring 86, which has its other end acting against the spacer tube 88 inside each piston rod 16B. The springs 86 provide a preload on the ball heads 76 and are not subjected to forces (other than the ones they exert) on the working strokes of the respective pistons. That is because a rigid connection is provided between the ball head 76 and the compressor piston head 14A by the spacer tube 82 and the socket half 78 on the power stroke of the compressor piston (i.e. going toward top dead center) and a rigid connection is provided between the ball head 76 and the vacuum piston head 16A on its power stroke (i.e. going toward bottom dead center) by the socket half 78 and the piston rod 16B being crimped over it. Alternatively, the ball and socket joint could be reversed, with the balls on the piston rods 14B, 16B and the sockets on the wobble member 60.

### SUMMARY OF THE INVENTION

In accordance with the invention a nutating air or gas pump is provided. The pump has a housing. A valve plate is disposed in the housing. An eccentric is disposed in the housing. A drive shaft is coupled to the eccentric. A yoke or nutating or wobble member is coupled to the eccentric. A piston having a head is coupled to the yoke. The piston head reciprocates in an axial direction within a cylinder of the pump when the pump is in operation.

A flexible and elastic member is connected to the yoke and to the housing. When the pump is in operation, the flexible member flexes to allow the yoke to nutate and wobble and tilt relative to the pump's axis so as to reciprocate the pistons in the axial direction while preventing the nutating member from rotating around an axis of the pump. The flexible member has a construction which can be generally tubular or planar. The flexible member can be elastic. The member can be made from rubber, plastic, paper, cloth, metal, and combinations thereof. The flexible member is an anti-rotation member.

The pump can further include a second flexible member coupled to the yoke and to the housing, wherein a ball of a ball joint is in hollow of the second flexible member.

The pump can further include a third flexible member coupled to the yoke and to the piston, wherein a ball of a ball joint is in a hollow of said third flexible member.

### BRIEF DESCRIPTION OF THE DRAWINGS

FIG. 1 is a cross-sectional, schematic view taken of a prior art pump.

FIG. 2 is a schematic cross-sectional view of a pump taken along the pump's longitudinal axis incorporating an embodiment of the invention.

FIG. 3 is an enlarged cross-sectional view showing the yoke assembly and housing cover.

FIG. 4 is a plan underside view of the yoke assembly shown in FIG. 3 wherein the anti-rotation member can more clearly be seen.

FIG. 5 is a top plan view of the elastomeric anti-rotation member shown in FIG. 4.

FIG. 6 is a cross-sectional view of the member shown in Figure taken along the members diameter.

FIG. 7 is an exploded perspective view of the assembly shown in FIG. 4.

FIG. 8 is an enlarged schematic sectional view more clearly showing the interface of a piston rod to the yoke assembly.

FIG. 9 is an alternative embodiment of the anti-rotation member shown in FIG. 5.

FIG. 10 is a schematic enlarged view of some of detail in FIG. 3 showing yet a further embodiment of an anti-rotation member.

FIG. 11 is a schematic cross-sectional view of a pump taken along the pump's longitudinal axis incorporating an alternative embodiment of the invention.

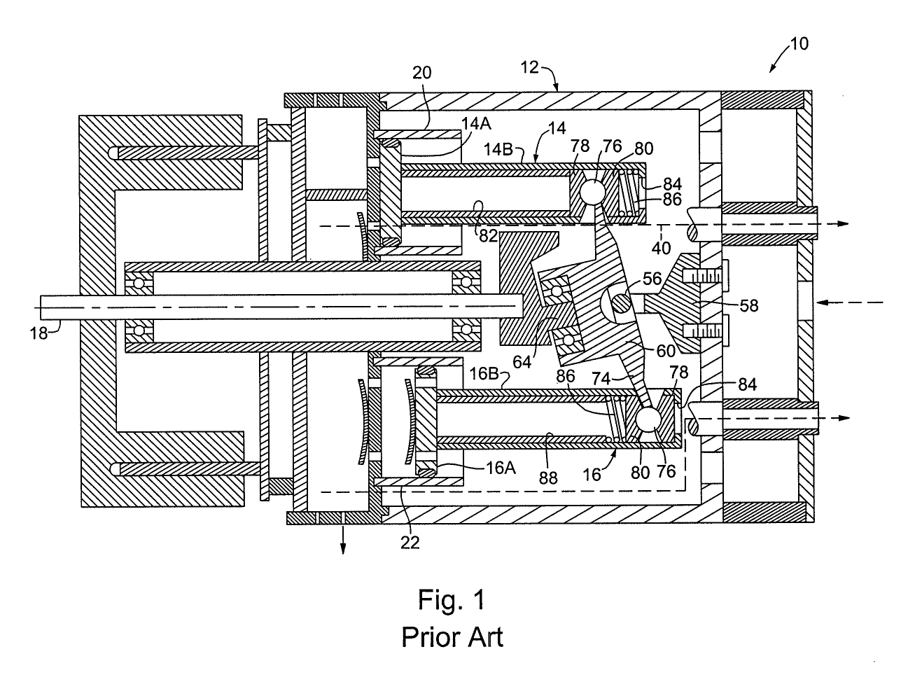

### DETAILED DESCRIPTION

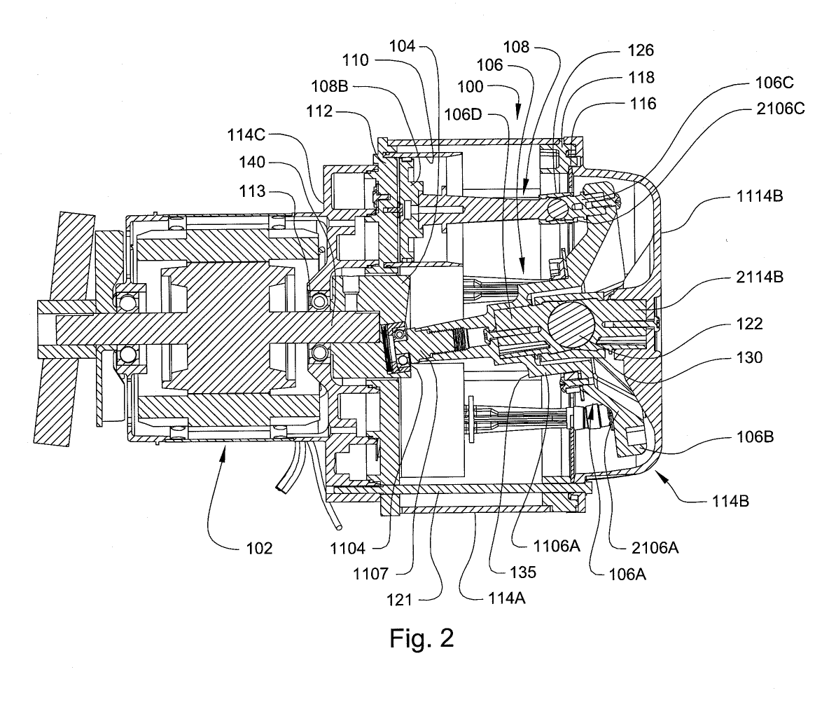

Referring now to FIG. 2, pump 100 embodying an example of the invention is shown. In general, the pump includes motor 102 coupled to eccentric 104. The eccentric is coupled to yoke 106. The yoke 106 is coupled to pistons 108. Each piston is disposed in a respective cylinder 110. The cylinders extend from a valve plate 112. The pump further has a housing 114 enclosing the eccentric 104, yoke 106, pistons 108, and cylinders 110. An anti-rotation member 116 prevents rotation of the yoke around the pump's axis during operation of the pump.

The housing includes a cylindrical central sidewall member 114A, a housing cover 114B and a support 114C for the valve plate 112 and bearing 113. The housing cover 114B is at one end of housing sidewall 114A and the support 114C is at the other end of housing sidewall 114A. A retainer 118 for retaining anti-rotation member 116 is disposed between the housing sidewall 114A and housing cover 114B. An alignment pin 121 aligns the housing cover 114B, retainer 118, housing sidewall 114A, valve plate 112 and support 114C with one another.

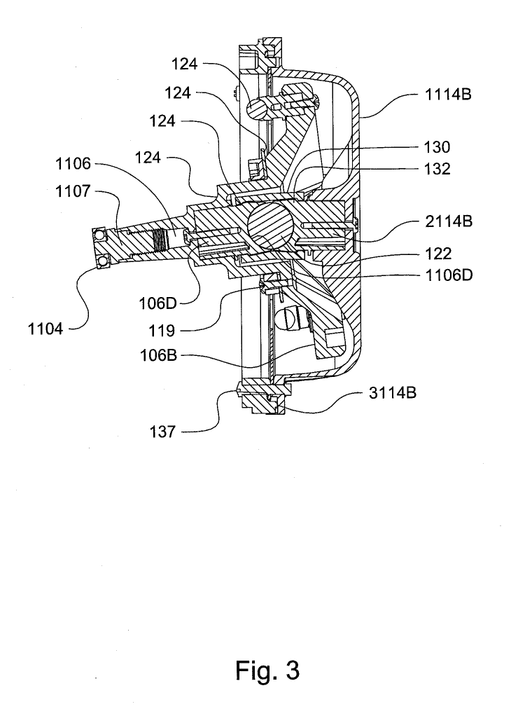

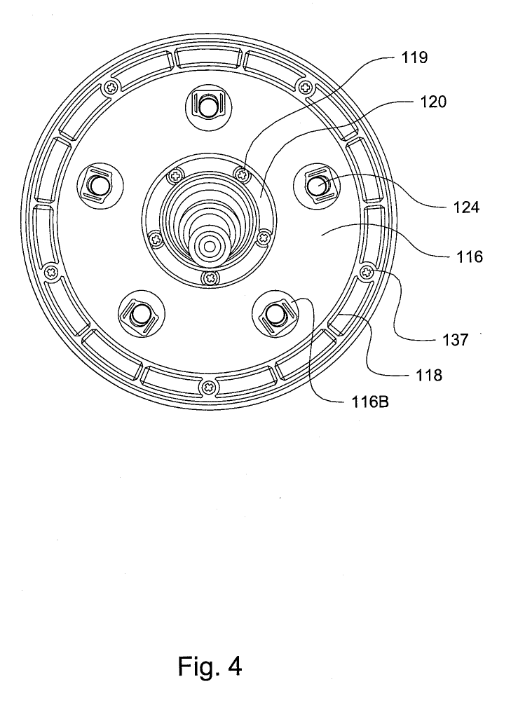

Now referring to FIGS. 2 and 3 the manner in which the yoke 106 is coupled to the housing 114A and to the eccentric 104 can be seen. The yoke 106 has a central portion 106A. The central portion 106A has a stepped cylindrical portion 1106A which is hollowed. The central portion also has a conical portion 2106A. The conical portion on its surface facing the housing cover is hollowed. The conical portion 2106A is circumscribed by a shoulder or ledge 106B. Extending from the ledge or shoulder portion towards support 114C are a plurality of posts or arms 106C. Extending from the cylindrical portion 1106A towards the housing cover is a pivot post 106D. The pivot post has a first end 1106D with a recessed portion to receive a ball 122. The pivot post 106D also has an end fastened to a bottom wall forming a bottom of the cylindrical portion 1106A.

A center pivot post 2114B extending downward from a top wall 1114B of said housing cover 114B forms a part of a ball joint coupling the yoke 106 to the housing 114. In more detail the center post 2114B, rod pivot post 106D, ball 122 flexible member 130 couples the yoke 106 to housing 114. The flexible member 130 in the form of an elastic and flexible boot or sleeve, helps to interconnect the center pivot post 2114B to the rod post 106D and helps to maintain ball 122 within the spherical recess of rod post 106D and spherical recess of center post 114B. The ball 122 is within a hollow formed by the member 130. The ball 122 can be affixed to post 2114B or 106D by way of a jam fit or swaging or insert molding. The flexible member 130 is secured to the outer surfaces of the center and rod posts by way of a resistance fit. To reduce the likelihood of elastomeric member 130 disconnecting from center post 2114B and rod post 106D, each have detents 132 to increase the friction fit. Although the ball 122 has been described as a separate item from pivot post 106D and center post 2114B, it could form a molded integral portion of either the center post 2114B or pivot post 106D. The center post 2114B or pivot post 106D would simply have ball ends instead of recessed ends. The ball joint (2114B, 106D, 122, 130) interconnects the yoke and housing. The boot 130 forms a protective sleeve.

FIG. 2 shows how the yoke 106 is coupled to eccentric 104. Yoke 106 at an end opposite yoke ledge 106B has a cylindrical recess 1106. A portion of a pin 1107 is disposed within the recess. An opposite portion of the pin 1107 is coupled to eccentric 104 by way of angular bearing 1104.

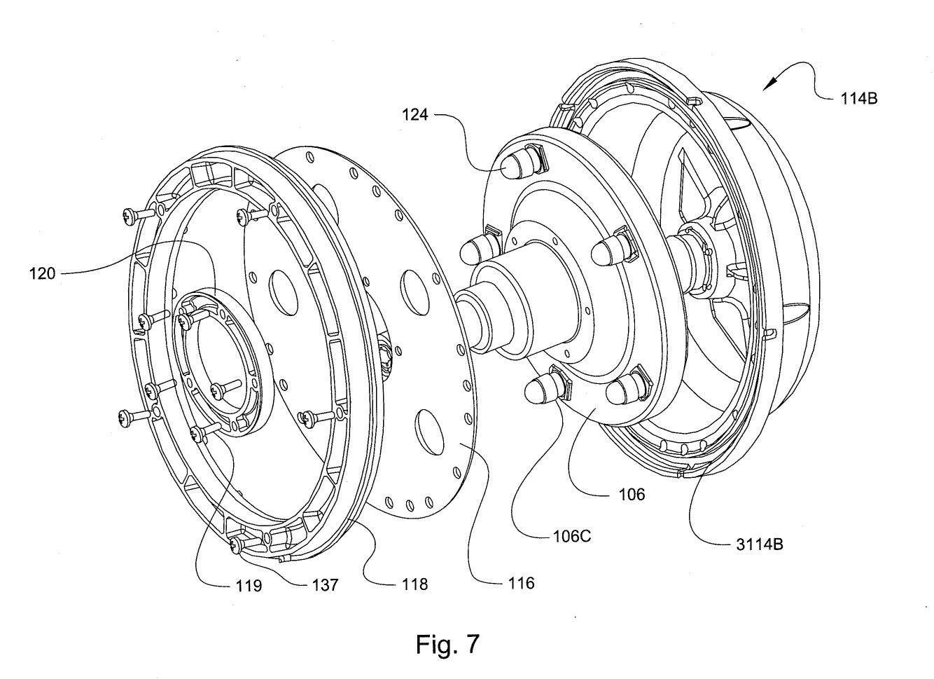

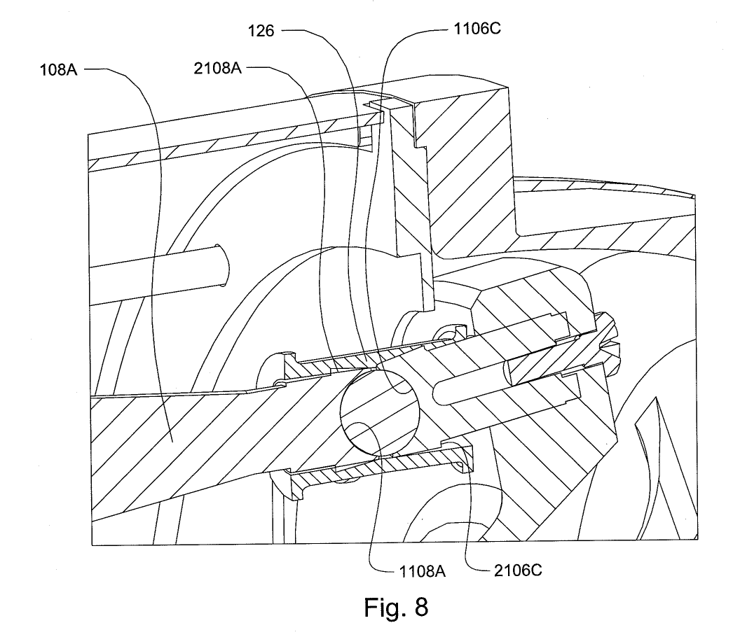

Referring now to FIGS. 2 and 7 details as to how the yoke arms 106C couple to the connecting rods 108A of each piston can be seen. Each arm 106C couples to a respective connecting rod 108A of a respective piston 108. The arms 106C and connecting rods 108A are designed to engage each other. Each arm 106C includes a detent 2106C and a spherical recess 1106C. The top portion of the connecting rod 108A has a spherical recess 1108A. The connecting rod also includes a detent 2108A towards the top of the rod. The spherical recesses 1106C and 1108A engage ball 124. A flexible member 126 in the form of an elastic boot or sleeve couples the rod 108A to the arm 106C with the ball 124 there between to form the ball joint. The ball 124 is within a hollow formed by boot 126. The boot 124 can be affixed to rod 108A or 106C by swaging or jam fitting or insert molding. The detents help to secure the sleeve 126. The sleeve may include interior features such as ridges or recesses within the hollow of the sleeve to provide a surface for detents to engage. Flexible member 26 is without sliding points and may be any type of tubular member such as a spring. Although the ball 124 has been described as a separate item from arm 106C and connecting rod 108A, it could form an integral molded portion of either the arm 106C or connecting rod 108A. The arms 106C or connecting rods 108A would simply have ball ends instead of recessed ends 1106C and 1108A. The ball joints (1106C, 1108A, 124, 126) interconnect the yoke 106 and pistons 108.

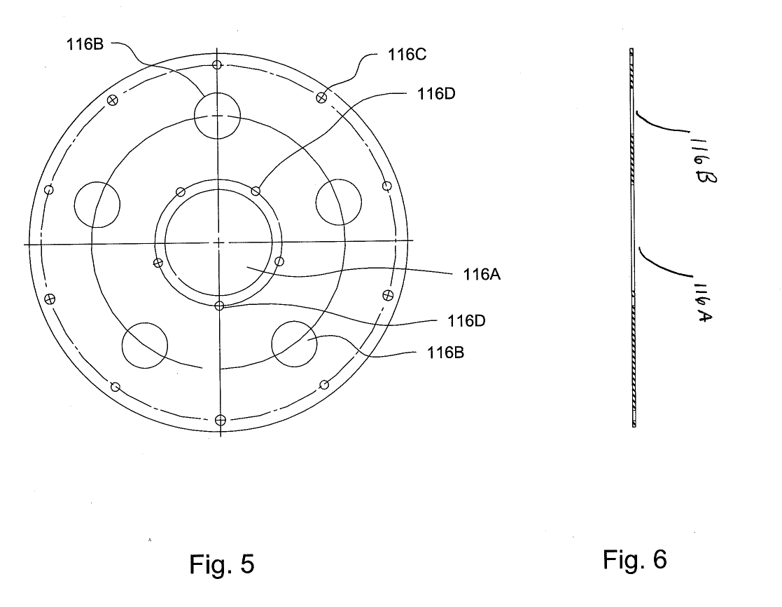

Another important feature of the invention, the anti-rotation member 116 can be seen more clearly in FIGS. 3, 5 and 6. The anti-rotation member 116 is a flexible and elastic and in the present embodiment is a rubber reinforced cloth sheet having a central bore 116A. The member 116 is without sliding joints such as ball joints or universal joints. Circumferentially arranged about counter bore 116A of a flexible member 116 are five through holes 116C. The flexible member, as can be seen, is a thin circular sheet.

The flexible member 116, when installed, sits between housing cover 114B and housing sidewall 114A. Retaining ring 118 secures member 116 to an underside of shoulder portion 3114B of housing 114B by way of fasteners 137 and through holes 116C. The yoke has a ledge or seat 135 formed at the junction of yoke conical portion 2106A and cylindrical portion 1106A.

The flexible member 116 having the through holes 116D is fastened to ledge or seat portion 135 of yoke 106 by way of a retaining ring 120 and fasteners 119.

The flexible member's central bore 116A receives cylindrical portion 1106A of yoke 106. The flexible and elastic member 116 is positioned so that each arm 106C of yoke 106 and each arm's respective connecting rod 108A are aligned with yoke arm receiving holes 116B. The yoke arms 106C, during operation, will reciprocate up and down in the receiving holes 116B.

The member 116 permits the yoke to nutate and wobble but prevents the yoke from rotating in the circumferential direction around post 2114B. The flexible member 116 thus ensures that the yoke, during operation of the pump, will reciprocate the pistons in the axial direction but that the yoke, although it will wobble and nutate about the pump's axis, will not rotate circumferentially about the center post 2114B. The member 116 has torsional rigidity to prevent rotation of the nutating member 106 around the axis of the pump.

The anti-rotation feature can take a variety of forms so long as it is a flexible member which, when connected to the yoke and housing, allows for the yoke to nutate or wobble about the pump's axis but exerts sufficient forces to inhibit rotation of the nutating member around the pump's axis so that the yoke can reciprocate the pistons when the pump is in operation. As can be seen the flexible member allows for flexing without the aid of sliding joints in its structure such as a ball joint or a universal joint.

In operation the motor turns crank shaft 140 which rotates eccentric 104. The rotation of the eccentric causes the pin 1107 to rotate about the shaft. The rotation of the pin 1107 causes the yoke to wobble or nutate. The wobbling or nutating causes the pistons 108 to reciprocate up and down in the axial direction. The ball joint (1114B, 106D, 122, 130) allows the yoke to wobble or nutate relative to the housing cover 114B. The ball joint (1108A, 124, 1106C, 126) allows the yoke to wobble and nutate relative to the piston's 108. The anti-rotation member 116 prevents rotation of the yoke about the pump's axis. The flexible and elastic member 116 flexes in a manner which allows the pump's to reciprocate in the axial direction but prevents rotation of the yoke 106 around the pump's axis.

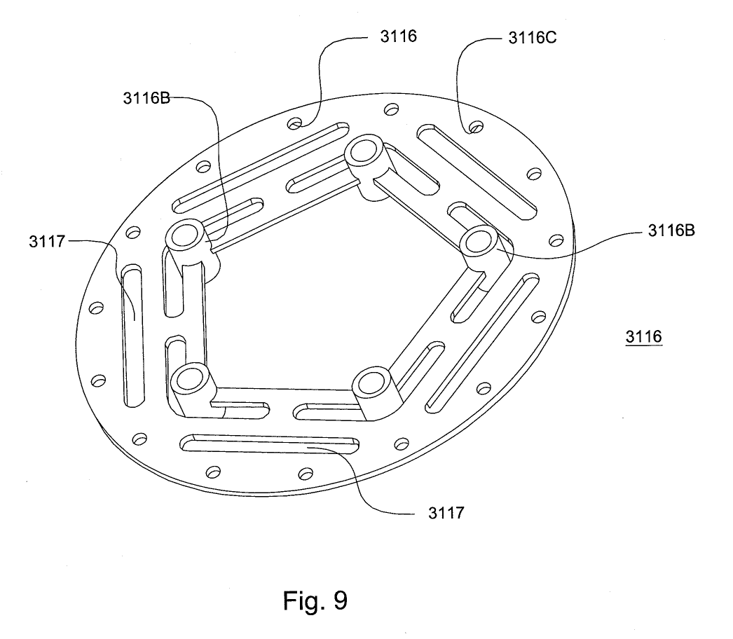

FIG. 9 shows another type of anti-rotation member 3116. Member 3116 is elastic and flexible. It can be considered a kind of flat spring. The member 3116 like member 116 is generally planar and thin. The member 3116 would be secured to housing cover 114B by way of fasteners which extend through holes 3116C. The member 3116 would be secured to yoke 106 by way of cylinders 3116B. The arms 106C of yoke 106 would be secured to member 3116 through cylinders 3116B. The cylinders 3116B would also connect the rods 108A to the yoke arms 106C. Channels 3117 in member 3116 allow for member 3116 to flex to allow for the yoke member 106 to wobble and tilt relative to the pump's axis but would inhibit member 106 from rotating circumferentially about its axis. Of course the member 3116 could be a leaf spring.

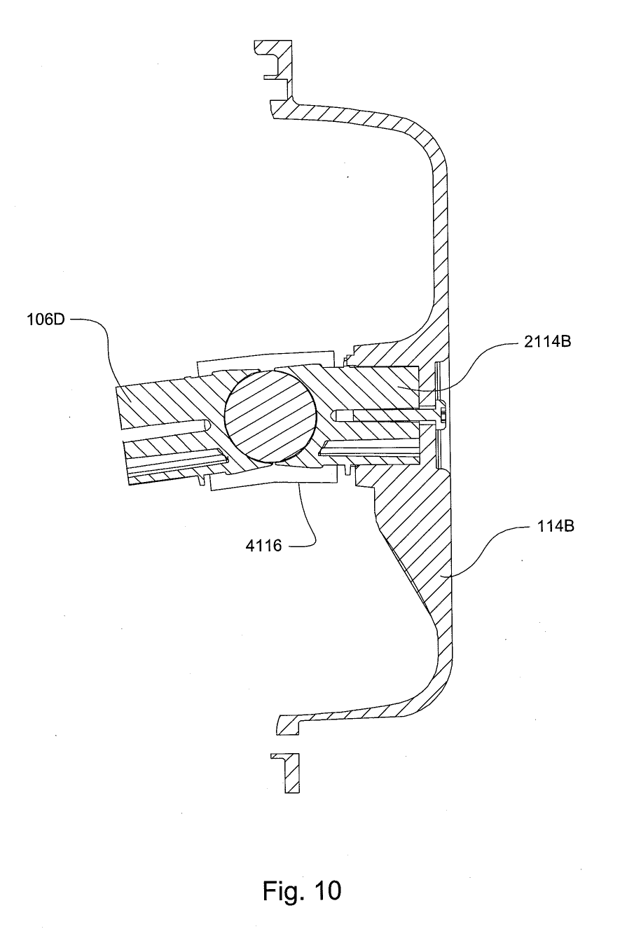

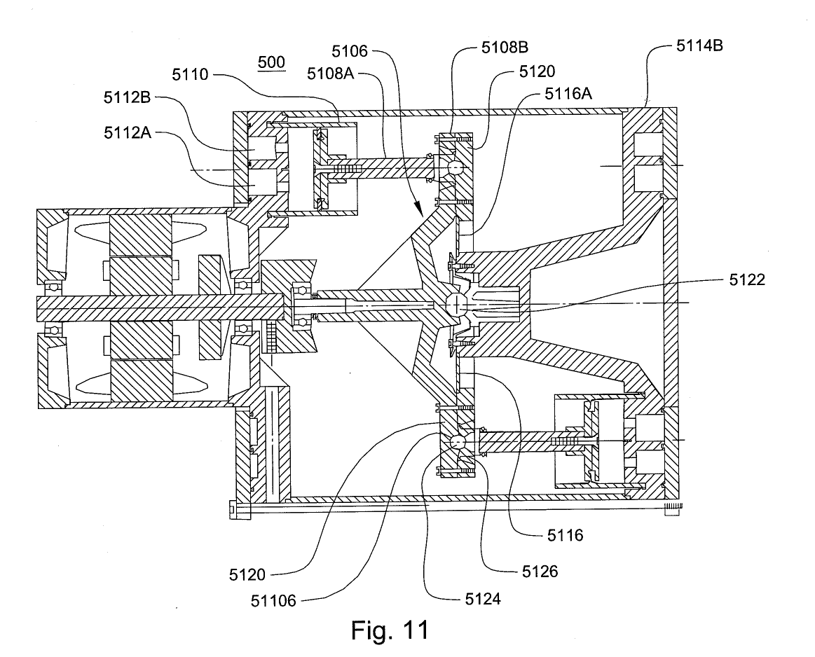

In addition to having a generally planar type construction the anti-rotation member could have a generally tubular construction. For instance the member could be a helical flat spring or bellow both generally represented as 4116. See FIG. 10. In this case the bellow or helical spring would interconnect center post 2114B and rod post 106D. The bellow or helical spring would exert sufficient forces to allow for the yoke to tilt relative to the pump's axis but prevent rotation of the yoke in the circumferential direction about the pump's axis.

FIG. 11 shows an alternate pump 500. The pump 500 is similar to pump 100 except it is a double ended nutating pump. For simplicity the components of pump 500 have been referenced to generally correspond to the numbering of the components in pump 100 except a “5” proceeds the numbering for pump 500. So for example, yoke 106 for pump 100 corresponds to yoke 5106 for pump 500, cylinder 110 for pump 100 corresponds to cylinder 5110 for pump 500 and so on. The structure of the components in some cases as shown in FIG. 11 do differ. Notably anti-rotation member 5116 is secured to housing cover and valve plate 5114B at member 5116′s central portion 5116A. Member 5116 is secured to yoke 5106 at the yoke's periphery 5106B. A retainer 5120 secures the yoke to member 5116 and receives ball 5124 in recess 51106C. Tubular member 5126 is integral with member 5116 and secures piston rod 5108A to yoke 5106. Ball 5122 is disposed between housing 5114B and yoke 5106.

Each piston during its upstroke draws air into a cavity formed by each piston's head 5108B and the cylinder 5110. The air is drawn through a pump intake into the housing and through a valve plate inlet 5112A in valve plate 5112. The piston on the down stroke exhausts the volume of air in the cavity formed by the piston cylinder through valve plate outlet 5112B in valve plate 5112 and through a pump outlet in the housing. The manner of placement of the inlets, outlets and valves to control the intake and exhaust of air through the pump is known.

Although the pump's shown are for air, the invention is equally applicable to liquid or gas type pump's. Also the invention could be used in connection with diaphragm type pump's as opposed to piston pump's. The invention can further be used in connection with both pressure and vacuum type applications.

1. A nutating air or gas pump comprising:
a housing;
a valve plate;
an eccentric disposed in said housing;
a drive shaft coupled to said eccentric;
a piston having a head, said piston is coupled to said yoke;
a cylinder extending from said valve plate wherein said piston head reciprocates in an axial direction within said cylinder of said pump when said pump is in operation;
a planar flexible member connected to said yoke and to said housing, and wherein said flexible member flexes in a manner to allow the yoke to tilt relative to an axis of said pump while restraining the yoke from rotating about the axis.

2. The nutating pump of the claims 1 wherein said flexible member has a construction selected from a group of constructions consisting of a sheet, or flat spring or leaf spring.

3. The nutating pump of claim 2 wherein said flexible member is elastic.

4. The nutating pump of claim 2 wherein said flexible member is made from a material selected from a group of materials consisting of rubber, plastic, paper, cloth, metal and combinations thereof.

5. The nutating pump of claim 1 wherein said pump further comprises:
a second flexible member coupled to said yoke and to said housing, and wherein a ball of a ball joint is in a hollow of said second flexible member.

6. The nutating pump of claim 5 where said flexible member is elastic.

7. The nutating pump of claim 1 wherein said pump further comprises:
a third flexible member coupled to said yoke and to said piston, and wherein a ball of a ball joint is in a hollow of said third flexible member.

8. The nutating pump of claim 7 wherein said third flexible member is integral with the first flexible member.

9. An assembly of a pump, said assembly interconnecting a yoke or nutating member to a housing, said assembly comprising:
a ball joint interconnecting said yoke to said housing;
a flexible member connected to said yoke and to said housing, said flexible member having a central opening, and wherein said flexible member flexes in a manner to allow the yoke to tilt relative to an axis of said pump while restraining the yoke from rotating about the axis.

10. The assembly of claim 9 wherein said flexible member has a construction selected from a group of constructions consisting of a sheet, bellow, or spring.

11. The assembly of claim 10 wherein said flexible member is elastic.

12. The assembly of claim 10 wherein said flexible member is made from a material selected from a group of materials consisting of rubber, plastic, paper, cloth, metal and combinations thereof.

13. The assembly of claim 9 wherein said assembly further comprises:
a second flexible member coupled to said yoke and to said housing, and wherein a ball of said ball join is in a hollow of said deformable member.

14. The assembly of claim 9 wherein said flexible member:
is without any sliding joints therein.

15. The assembly of claim 14 wherein said flexible member is generally planar.

16. A nutating pump, the nutating pump comprising:
a housing;
a nutating yoke positioned within said housing, the yoke having an arm;
a connecting rod aligned with the arm and coupled to a piston at a first end;
a cylinder adapted to accept said piston; and
a flexible member secured to the arm and to the rod to pivotally couple the arm to the rod so that the rod and arm remain connected during reciprocation of the piston within the cylinder.

17. The nutating air or gas pump of claims 1 where the flexible member has a central opening which receives a portion of said yoke.

18. The assembly of claim 14 wherein said central opening receives a portion of said yoke.

19. An assembly of a pump, said assembly interconnecting a yoke or nutating member to a housing, said assembly coupling an eccentric to a nutating yoke said assembly comprising:
a ball joint interconnecting said yoke to said housing;
a pin coupling said eccentric to said yoke
a member connected to said yoke and to said housing, and wherein said flexible member flexes in a manner to allow the yoke to tilt relative to an axis of said pump while restraining the yoke from rotating about the axis, wherein the planar flexible member has a central opening therein.

20. (canceled)

21. (canceled)

22. A planar flexible member of a pump, said pump having a yoke connected to a housing of said pump, said flexible member is connected to said yoke and to said housing, said flexible member has a central opening, and wherein said flexible member flexes in a manner flexes in a manner to allow the yoke to tilt relative to an axis of said pump while restraining the yoke from rotating about the axis.

23. A flexible member of a pump, said pump having a yoke connected to a housing of said pump by way of a ball joint, said flexible member is connected to said yoke and to said housing, said flexible member has a central opening, and wherein said flexible member is without any sliding joints therein connecting said yoke to said housing.

24. (canceled)

25. (canceled)
